(19) United States
(12) Patent Application Publication
(10) Pub. No.: US 2024/0145664 A1
(43) Pub. Date: May 2, 2024

(54) HOT-PRESSED CARBON/SULFUR COMPOSITE ENERGY-STORAGE CATHODE, A METHOD OF MANUFACTURING THE CATHODE, AND THE LITHIUM-SULFUR BATTERY USING THE SAME

(71) Applicant: NATIONAL CHENG KUNG UNIVERSITY, Tainan City (TW)

(72) Inventors: Sheng-Heng CHUNG, Tainan City (TW); Cheng-Che WU, Tainan City (TW)

(73) Assignee: NATIONAL CHENG KUNG UNIVERSITY, Tainan City (TW)

(21) Appl. No.: 18/088,241

(22) Filed: Dec. 23, 2022

(30) Foreign Application Priority Data
Oct. 31, 2022 (TW) 111141393

(51) Int. Cl. H01M 4/04; H01M 4/38; H01M 4/66; H01M 10/052

(52) U.S. Cl. CPC H01M 4/043; H01M 4/38; H01M 4/663; H01M 10/052; H01M 2004/028

(57) ABSTRACT

The present invention provides a hot-pressed carbon/sulfur composite energy-storage cathode utilized in a lithium-sulfur battery, comprising: a conductive porous substrate with specific surface area of 1˜100 m²/g before sulfur loading, and a sulfur layer formed on the conductive porous substrate by hot-pressing method; the cathode has a sulfur loading of 8 mg/cm² and a sulfur content of 73 wt %. The lithium-sulfur battery of the present invention, with the significant enhancement of the loading and the content of the active material achieved by the hot-pressed carbon/sulfur composite energy-storage cathode, may have the effect of high cyclability and high energy density in a lean-electrolyte lithium-sulfur battery with a low electrolyte-to-sulfur ratio of 7˜4 μL/mg.

### CROSS-REFERENCE TO RELATED APPLICATIONS

This application claims the benefit of priority of Taiwan Application Number TW111141393, filed Oct. 31, 2022, which is herein incorporated by reference in its entirety.

### TECHNICAL FILED

The present invention relates to a cathode utilized in a lithium-sulfur battery, a method of manufacturing and the lithium-sulfur battery thereof.

### BACKGROUND

It is believed that lithium-sulfur batteries have enormous potential in the lithium batteries development field. However, there are some defects like low cyclability and insufficient energy density in most of available developed lithium-sulfur batteries. Generally, polysulfide leaking is prevented by disposing additional active material trapping layer between cathode of batteries and polymer separator to enhance cyclability of batteries.

Additionally, carbon/sulfur composite cathode was mainly manufactured by the method of mixing sulfur powder or sulfur contained composite, conductive carbon black and binder to form slurry and coating the slurry on an aluminum foil current collector with a doctor blade to form the carbon/sulfur composite cathode in the past. The process of the method of manufacturing cathode mentioned above included cumbersome steps including mixing slurry, electrode coating, pole piece drying and tableting processes, which led to time-consuming batteries manufacturing process. Also, preparing additional added trapping layer increases cost of manufacturing process and complexity and difficulty of manufacturing process of components and elements of batteries.

To achieve lithium-sulfur batteries with high energy density, electrodes with high sulfur loading are needed. However, while increasing the sulfur loading, the high insulation property of pure sulfur also cause problem. To solve the insulation problem caused by pure sulfur, one of the common solutions is to add a large amount of conductive carbon black in the cathode manufacturing process and prepare sulfur contained composite (i.e. applying porous carbon, carbon tube, carbon fiber, conductive polymers etc.). However, conductive carbon black and other composite components need to be added coupled with binder to decrease the proportion of active material in the cathode. Also, limited by the method of manufacturing, the loading of active material in the electrode cannot be enhanced. Additional added trapping layers will also decrease the content of active material in the batteries, which stop the content of active material from increasing.

### SUMMARY

Accordingly, the present invention provides a cathode utilized in a lithium-sulfur battery, a method of manufacturing and the lithium-sulfur battery thereof. The purpose of the present invention is to increase the cyclability, the loading of active material and the energy density of batteries to high level.

One of aspects of the present invention is a hot-pressed carbon/sulfur composite energy-storage cathode comprising: a conductive porous substrate with specific surface area of 1˜100 m²/g before sulfur loading, and a sulfur layer formed on the conductive porous substrate; the cathode has a sulfur loading of at least 3 mg/cm² and sulfur content of at least 60 wt %.

The term “sulfur loading” used in the present invention is defined as the total weight (mg) of the active material sulfur added into the batteries. Only the total weight of sulfur in the cathode region is counted because sulfur is only added in the cathode region of batteries due to the electrochemical reaction characteristics and battery structure. In some embodiments, the sulfur loading of the hot-pressed cathode of the present invention is at least 3 mg/cm², preferably at least 5 mg/cm², further preferably at least 8 mg/cm². In some embodiments, the sulfur loading of the hot-pressed cathode of the present invention is between 3˜15 mg/cm², preferably 5˜12 mg/cm², further preferably 7˜10 mg/cm². In some embodiments, the sulfur loading of the hot-pressed cathode of the present invention is 8 mg/cm².

In some embodiments, the sulfur content of the hot-pressed cathode of the present invention is at least 60 wt %, preferably 60˜95 wt %, further preferably 70˜80 wt %. In some embodiments, the sulfur content of the hot-pressed cathode of the present invention is about 73 wt %.

Regarding the hot-pressed carbon/sulfur composite energy-storage cathode of the present invention, preferred is the conductive porous substrate is electrospun fiber carbon paper.

Regarding the hot-pressed carbon/sulfur composite energy-storage cathode of the present invention, preferred is the conductive porous substrate has a weight per unit area of 1.0-2.0 mg/cm².

Regarding the hot-pressed carbon/sulfur composite energy-storage cathode of the present invention, preferred is the conductive porous substrate has an average pore diameter of 10.22 nm before sulfur loading.

Another aspect of the present invention is a method of manufacturing a hot-pressed carbon/sulfur composite energy-storage cathode comprising:
a substrate preparing step of manufacturing fiber of polymers by electrospinning to obtain an electrospun fiber substrate which undergoes stabilization in air and then is heated in nitrogen for carbonization to obtain electrospun fiber carbon paper;
a hot-pressing step of dispersing sulfur powder evenly on a sheet of the electrospun fiber carbon paper, covering its top layer with another sheet of the electrospun fiber carbon paper and then hot-pressing the two sheets of the electrospun fiber carbon paper to form the hot-pressed carbon/sulfur composite energy-storage cathode.

Regarding the method of manufacturing a hot-pressed carbon/sulfur composite energy-storage cathode of the present invention, preferred is the substrate preparing step is conducted by using spinning solution of 10 wt % polyacrylonitrile and collecting spinning fiber with a voltage of 18˜20 kV, a solution advancing speed of 1.5 mL/min and a rotational speed of 70 rpm using a roller type collector to obtain the electrospun fiber substrate.

Regarding the method of manufacturing a hot-pressed carbon/sulfur composite energy-storage cathode of the present invention, preferred is the hot-press step is conducted with a temperature of 145° C. and a pressure of 200 psi.

In addition, another aspect of the present invention is a lithium-sulfur battery having the previously described cathode and electrolyte with electrolyte-to-sulfur ratios of 7˜4 μL/mg.

Regarding the lithium-sulfur battery of the present invention, preferred is the areal specific capacity of the lithium-sulfur battery is 5.9˜4.3 mA·h/cm².

Regarding the lithium-sulfur battery of the present invention, preferred is the energy density of the lithium-sulfur battery is 8.5˜11.8 mW·h/cm².

The content and loading of active material in the electrode of the lithium-sulfur battery formed by using the cathode of the present invention can be increased. The active material in the electrode adopts sulfur powder in the present invention. In addition, there is no need to dispose additional current collector and trapping layer while adopting the cathode of the present invention which can function as current collector and trapping layer at the same time.

In addition, the cathode of the present invention is manufactured by hot-pressed method, resulting in a large amount of cathode material can be continuously manufactured in a short period of time. Compared to the cumbersome manufacturing process in which it is needed to dispose additional current collector and trapping layer in the prior art, production can be conducted easily and quickly by the manufacturing method of the present invention.

The lithium-sulfur battery of the present invention utilizes hot-pressed method coupled with electrospun fiber carbon paper with low porosity to effectively enhance the bonding between active material and conductive material, successfully reduce the amount of electrolyte needed and achieve a low electrolyte-to-active-material ratio of 7˜4 μL/mg. Compared to the high electrolyte-to-active-material ratio in the prior art, the lithium-sulfur battery of the present invention can have more excellent battery performance. Also, high cyclability and high energy density of battery can be achieved due to the significant increase in the content and loading of active material of lithium-sulfur battery.

### BRIEF DESCRIPTION OF THE DRAWINGS

FIG. 1A represents the figure of thermogravimetric analysis of the hot-pressed carbon/sulfur composite energy-storage cathode of Example before cycles.

FIG. 1B represents the figure of thermogravimetric analysis of the cycled hot-pressed carbon/sulfur composite energy-storage cathode of Example.

FIG. 2 represents the lithium-ion diffusion coefficient of the high-loading hot-pressed carbon/sulfur composite energy-storage cathode in the lithium-sulfur battery of Example.

FIG. 3 represents the electrochemical impedance spectra of the high-loading sulfur cathode of Example.

FIG. 4 represents the figure of rate-dependent cyclic voltammograms of Example.

FIG. 5 represents the rate performance from C/20 to C/2 of the lithium-sulfur battery of Example.

FIG. 6 represents the figure of testing the cycling performance of the lithium-sulfur battery of Example.

FIG. 7 represents the figure of testing the cycling performance of the lithium-sulfur battery of Example and Comparative Example.

FIG. 8A represents the figure of external morphology of the as-prepared hot-pressed carbon/sulfur composite energy-storage cathode of the Example inspected by scanning electron microscopy/energy-dispersive X-ray spectroscopy (SEM/EDS).

FIG. 8B represents the figure of internal morphology of the as-prepared hot-pressed carbon/sulfur composite energy-storage cathode of the Example inspected by scanning electron microscopy/energy-dispersive X-ray spectroscopy (SEM/EDS).

FIG. 8C represents the figure of external morphology of the cycled hot-pressed carbon/sulfur composite energy-storage cathode of the Example inspected by scanning electron microscopy/energy-dispersive X-ray spectroscopy (SEM/EDS).

FIG. 8D represents the figure of internal morphology of the cycled hot-pressed carbon/sulfur composite energy-storage cathode of the Example inspected by scanning electron microscopy/energy-dispersive X-ray spectroscopy (SEM/EDS).

FIG. 9 represents the X-ray diffraction analysis of the cathode of the Example.

FIG. 10 represents the Raman spectral analysis of the cathode of the Example.

FIG. 11 represents the X-ray photoelectron spectroscopy of the external surface of cathode of the Example.

FIG. 12 represents the X-ray photoelectron spectroscopy of the internal surface of cathode of the Example.

FIG. 13 represents the discharge/charge voltage profile of the high-loading cathode in the lean-electrolyte lithium-sulfur batteries of the Example at various cycling rates.

FIG. 14A, FIG. 14B, FIG. 14C and FIG. 14D represent the discharge/charge voltage profile of the high-loading cathode in the lean-electrolyte lithium-sulfur batteries of the Example at (FIG. 14A) C/10, (FIG. 14B) C/7.5, (FIG. 14C) C/5, and (FIG. 14D) C/3 rates.

FIG. 15A, FIG. 15B, FIG. 15C and FIG. 15D represent the discharge/charge voltage profile of the high-loading cathode in the lean-electrolyte lithium-sulfur batteries of the Example with electrolyte-to-sulfur ratios of (FIG. 15A) 7, (FIG. 15B) 6, (FIG. 15C) 5, and (FIG. 15D) 4 μL/mg at a C/10 rate.

FIG. 16 represents the manufacturing flow chart of the cathode of the Example.

### DETAILED DESCRIPTION

The content of the present invention will be illustrated by the following Examples. The Examples of the present invention are not intended to limit the present invention to be only realized in any specific environment, application or special way as described in Examples. Thus, the illustration about Examples is only for the purpose of describing the present invention, not for limiting the present invention.

Specifically, the hot-pressed carbon/sulfur composite energy-storage cathode of the embodiment uses porous carbon electrospun substrate as conductive porous substrate, i.e. electrospun fiber carbon paper constituted by nonwoven carbon nanofiber with low nanoporosity. The electrospun fiber carbon paper is also used as porous current collector and interlayer. In such cathode, sulfur is immersed by hot-pressed in the middle of the cathode and stays steady due to the structure of the cathode during cycling.

In addition, the cathode of the embodiment has a high sulfur loading of at least 3 mg/cm² and high sulfur content of at least 60 wt % because the electrospun fiber carbon paper of the embodiment is quite light. Specifically, the electrospun fiber carbon paper of the embodiment has a weight per unit area of 1.0-2.0 mg/cm² and specific surface area of 1˜100 m²/g before sulfur loading. Also, the electrospun fiber carbon paper has a high conductivity of 20 S/cm. Thereby, porous space for hosting the active materials, rather than a loose substrate, in the cathode is provided.

The conductive porous substrate of the embodiment allows electrons to transfer to non-conductive active solid materials quickly while quick consuming of electrolyte is prevented by the porous cathode made of conductive carbon fiber with low nanoporosity and low surface area and therefore the lithium ion is stopped from diffused. In addition, the network space of the cathode configuration decelerates the fast loss of active liquid-state materials, thereby averting its redeposition and the subsequent formation of insulating active solid-state material outside of the cathode substrate during cycling and solving the problem of loss of active materials and insulation in the prior art.

With the described constitution, the lithium-sulfur battery of the embodiment can have small amount of electrolyte with a low electrolyte-to-sulfur ratio of 7˜4 μL/mg for lean-electrolyte battery. In addition, the three-phase boundary of sulfur, electrode substrate, and electrolyte is improved by hot pressing process, thereby enhancing electrochemical stability and reversibility. The lithium-sulfur battery of the embodiment can have excellent battery performance such as a high discharge capacity of 740 mA·h/g and excellent rate performance of a prolonged cycle life of 200 cycles at C/10 to C/3 rates.

The constitution of the hot-pressed carbon/sulfur composite energy-storage cathode lithium-sulfur battery of the embodiment can largely enhance the loading and content of the active materials to alleviate the problem of insufficiency of active materials of the conventional technique. It also shows excellent electrochemical utilization and stability performance in electrochemical cycling tests for lean-electrolyte batteries such as high areal specific capacity of up to 6 mA·h/cm² and high energy density of up to 12 mW·h/cm² which are all higher than the minimum areal specific capacity and energy density required for powering the available electric vehicle (2-4 mA·h/cm² and 10 mW·h/cm²) and has prolonged cycling stability (200 cycles) and excellent rate performance (C/20-C/2), compared with the conventional high-sulfur electrodes or lean-electrolyte batteries with the electrical performance of cyclability of only 100 or less cycles and being unable to cycle at rates more than C/10.

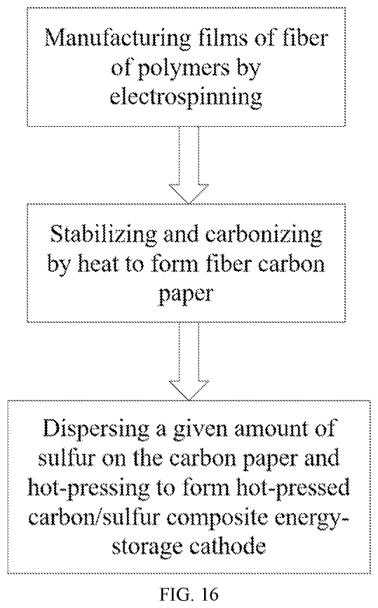

The method of manufacturing a hot-pressed carbon/sulfur composite energy-storage cathode of the embodiment comprises:
a substrate preparing step of manufacturing fiber of polymers by electrospinning to obtain an electrospun fiber substrate which undergoes stabilization in air and then is heated in nitrogen for carbonization to obtain electrospun fiber carbon paper; a hot-pressing step of dispersing sulfur powder evenly on a sheet of the electrospun fiber carbon paper, covering its top layer with another sheet of the electrospun fiber carbon paper and then hot-pressing the two sheets of the electrospun fiber carbon paper to form the hot-pressed carbon/sulfur composite energy-storage cathode. The manufacturing flow chart of the hot-pressed carbon/sulfur composite energy-storage cathode of the embodiment is shown in FIG. 16 and the detailed manufacturing steps are described the following Examples.

### Examples

[Electrospun Fiber Carbon Paper]

Add 1.2 g polyacrylonitrile (Sigma Aldrich, average mass average molar mass of 150,000) into 10.8 g dimethyl formamide (DMF) and mix at room temperature until the liquid is light yellow, transparent, and clear to prepare spinning solution with 10 wt % polyacrylonitrile. Electrospinning is conducted with the spinning solution and collect spinning fiber with a high voltage of 18˜20 kV, a solution advancing speed of 1.5 mL/min and a rotational speed of 70 rpm using a roller type collector during electrospinning process to obtain the electrospun fiber substrate. The obtained electrospun fiber substrate undergoes stabilization in air at 280° C. for 5 hours and then undergoes carbonization in nitrogen at 1000° C. at heating rate of 2° C./min for 1 hours to obtain electrospun fiber carbon paper with a weight per unit area of 1.5±0.2 mg/cm² and thickness of 20-30 μm.

[Electrolyte]

Electrolyte is obtained by adding 5.05 g Lithium bis(trifluoromethanesulfonyl)imide (LiC₂F₆NS₂O₄, 1.85 M) and 0.13 g lithium nitrate (LiNO₃, 0.2 M) into 4 mL glycol dimethyl ether (C₄H₁₀O₂) and 5.5 mL 1,3-dioxolane (C₃H₆O₂) and mixing at room temperature until the liquid is clear.

[Hot-Pressed Carbon/Sulfur Composite Energy-Storage Cathode]

Hot-pressed carbon/sulfur composite energy-storage cathode is manufactured with the electrospun fiber carbon paper and pure sulfur powder (Alfa Aesar, 99.5%). First, cut the electrospun fiber carbon paper into size of 1×1 cm² and heat the sulfur powder between the two layers of electrospun fiber carbon paper to 145° C. Then, press the molten sulfur at the pressure of about 200 psi into the carbon substrate to form hot-pressed carbon/sulfur composite energy-storage cathode. The amount of the sulfur powder added between the two layers of electrospun fiber carbon paper in this step is 8 mg to form cathode with sulfur loading of 8 mg/cm² and sulfur content 73 wt %. However, a person of ordinary skill in the art will appreciate that the amount of added sulfur powder is may be adjusted as required as long as the technical effects of the present invention can be achieved. The present invention is not intended to limit the amount of added sulfur powder to the disclosure.

It takes about only 5 seconds to complete the manufacturing process of the cathode of the Example by automation. Therefore, the cathode can be manufactured in very short time and suitable for continuous mass production.

[Lithium-Sulfur Battery]

The lithium-sulfur battery of the Example is a coin cell lithium battery assembled with the hot-pressed carbon/sulfur composite energy-storage cathode, a polymeric separator (Celgard) and a lithium-foil counter/reference anode under an argon atmosphere. Add the electrolyte into the battery and adjust the electrolyte-to-sulfur ratio to 7 μL/mg to form lean-electrolyte lithium-sulfur battery. In addition, lean-electrolyte lithium-sulfur batteries with the electrolyte-to-sulfur ratio of 6, 5 and 4 μL/mg are individually assembled. The battery performance of these lean-electrolyte lithium-sulfur batteries are tested by the following methods at set cycling conditions. See more details in Table 2 (Examples 1-5).

### Comparative Example

The battery of comparative example is assembled in the same way as the above lithium-sulfur batteries, except the cathode materials. To prepare the cathode of comparative example, blade slurry prepared by using 70 wt % sulfur, 15 wt % conductive carbon (Super P, Alfa Aesar, 99+%) and 15 wt % polyvinylidene fluoride (PVDF) as binder (sulfur content of electrode is 70 wt %) is coated evenly on an aluminum foil current collector with a doctor blade and pole piece with sulfur loading of 8 mg/cm² is chosen to assemble battery.

[Thermogravimetric Analysis]

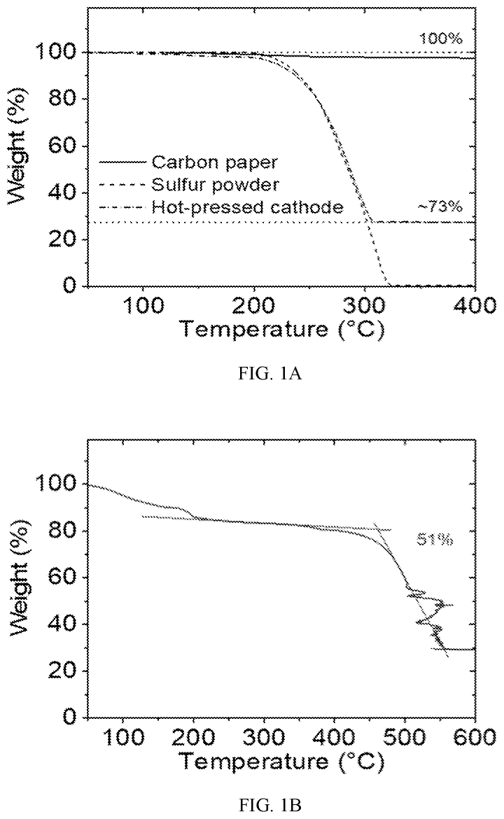

Thermogravimetric analysis was performed from 50 to 400° C. under a nitrogen atmosphere with thermogravimetric analyzer (Perkin Elmer, TGA4000). The results were shown in FIG. 1A and FIG. 1B. In the weight-loss range of the limited decomposition of the robust carbon substrate and the complete decomposition of sulfur, the as-prepared cathode (FIG. 1A) and cycled cathode (100 cycles) (FIG. 1B) had sulfur contents of 73 wt % and 51 wt %, respectively. The analysis results showed the high content (73 and 51 wt %) and retention (70%) of the active materials in the cathode. These results demonstrated that the hot-pressing strategy provides an excellent seal and stabilizes the sulfur fiber network in the porous electrode substrate made from the conductive electrospinning.

[Porosity Analysis]

The specific surface area and porosity of the electrospun fiber carbon paper and hot-pressed carbon/sulfur composite energy-storage cathode were analyzed with surface area and pore size analyzer (Anton Paar, Autosorb-iQ, set at −196° C. from 10⁻⁵ to 1.0 P/P0). The analysis results were shown in Table 1.

TABLE 1

| | | | Average |
|---|---|---|---|
| | specific | Total | pore |
| | surface area | pore volume | diameter |
| electrospun fiber carbon | 22.81 m²/g | 0.0583 cm³/g | 10.22 nm |
| paper | | | |
| hot-pressed carbon/sulfur | 25.03 m²/g | 0.0221 cm³/g | 3.53 nm |
| composite energy-storage | | | |
| cathode | | | |

Porosity analysis showed the non-nanoporous structure of the carbonized electrospinning fibers before and after being hot-pressed with sulfur. The analytical results of crystalline sulfur in a non-nanoporous carbon substrate indicated that the active material was hosted in the empty space of the carbon fibers and the electrode configurations rather than in a highly porous surface and loose skeleton of a conductive substrate. This enables the cathode of the Example to tolerate a lean electrolyte condition.

[Electrochemical Analysis]

Electrochemical impedance spectra from 0.1 MHz to 10 mHz and the cyclic voltammograms (CV) at potential sweeping rates of 0.020, 0.025, 0.030, and 0.035 mV/s between voltages of 1.5 and 3.0 V were analyzed with a potentiostat (Biologic, BCS-805). The electrochemical impedance data (shown as data points) were analyzed and fitted with an equivalent circuit model (shown as a fitting curve) to study the impedance units. The rate-dependent CV data were collected, and the peak current (iₚₑₐₖ) and potential sweeping rates (rate) were obtained according to the written Randles-Sevcik equation to investigate the lithium-ion diffusion coefficient (coefficient_{(Li-ion)}); iₚₑₐₖ=268,600×e^{1.5}×area×coefficient_{(Li-ion)}^{0.5}×concentration_{(Li-ion)}×rate^{0.5}. e is the number of electrons, area is the cathode area, and concentration_{(Li-ion)} is the lithium-ion concentration in the electrolyte. According to fundamental battery electrochemistry, the cyclability at constant cycling rates of C/10, C/7.5, C/5, and C/3 for 200 cycles and the rate performance at changing cycling rates of C/20, C/10, C/7.5, C/5, C/3, C/2, and C/20 were evaluated with a programmable battery cycler (NEWARE, CT-4008-5V10 mA) between 1.6 and 2.6 V at room temperature. The corresponding discharge/charge voltage profile was collected for investigation of the discharge and charge reactions.

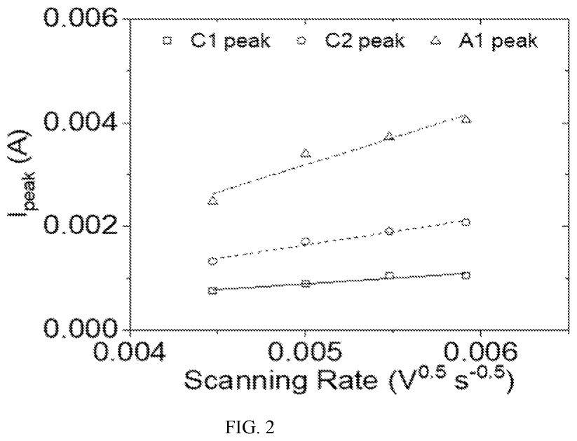

As shown in FIG. 2, the rate-dependent CV measurements reveal a stable redox reaction and low polarization between sulfur and sulfides, and high lithium-ion diffusion coefficients of 2.4×10⁻⁸, 1.3×10⁻⁷, and 5.6×10⁻⁷ cm²/s are obtained from the peak current and potential sweeping rates

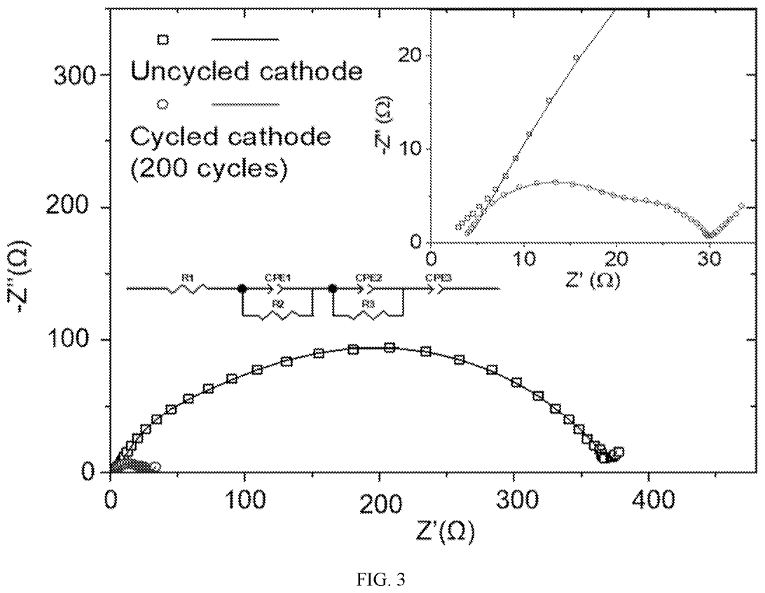

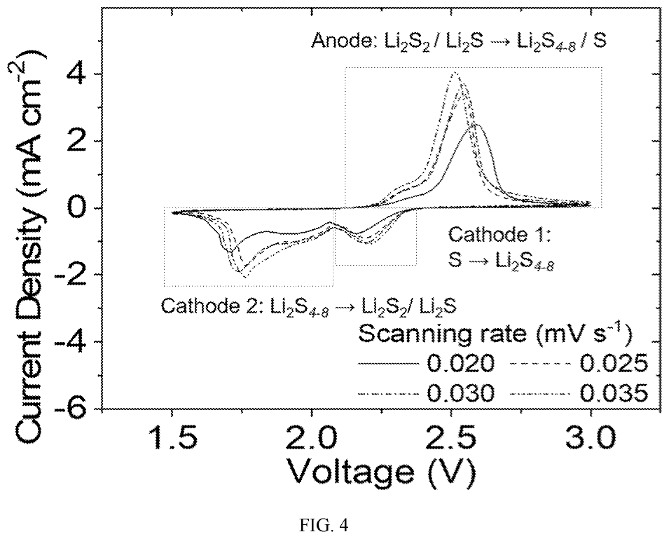

FIG. 3 is the electrochemical impedance spectra of the high-loading sulfur cathode of Example. FIG. 4 is the figure of rate-dependent cyclic voltammograms of Example, wherein the sweeping rates are 0.020 to 0.035 mV/s. As a result of stabilizing the nonconductive sulfur in the conductive cathode substrate, low resistance, high reversibility, and high stability were shown respectively. The hot-pressed carbon/sulfur composite energy-storage cathode of the Example with high sulfur loading and high sulfur content had low resistance of 372 and 30Ω before and after cycling, respectively, in the lean-electrolyte lithium-sulfur battery. This result indicates that the conductive substrate allows fast electron transfer toward the nonconductive active solid-state materials, whereas the porous cathode made from conductive carbon fiber with low nanoporosity and low surface area avoids fast electrolyte consumption that would prevent lithium-ion diffusion. In addition, the network space of the cathode configuration decelerates the fast loss of active liquid-state materials, thereby averting its redeposition and the subsequent formation of insulating active solid-state material outside of the cathode substrate during cycling. Thus, FIG. 4 shows overlapping curves that confirm the stable cathodic reaction from sulfur to polysulfides and sulfides (lower right frame and lower left frame) and the reversible anodic reaction from sulfides to polysulfides and sulfur (upper frame).

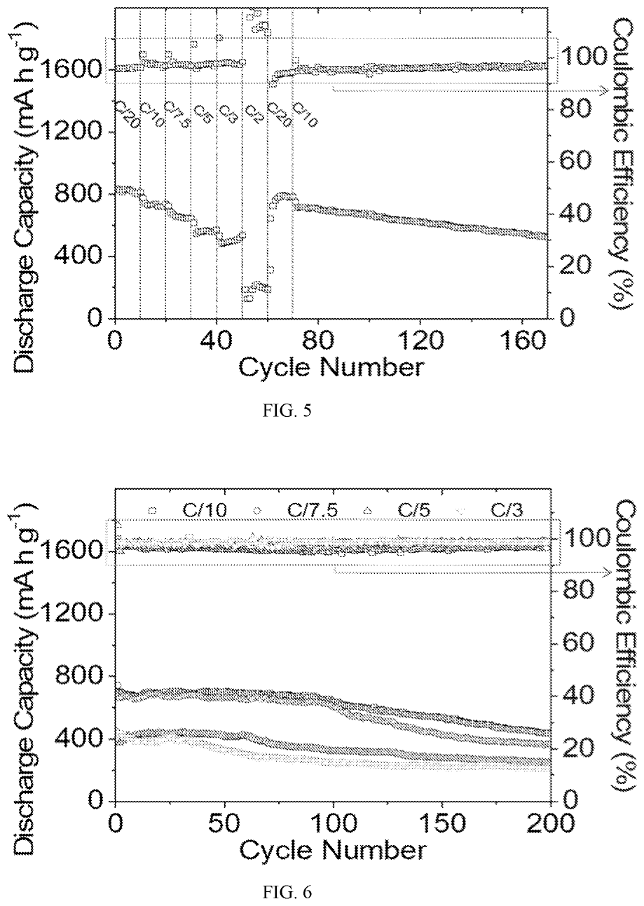

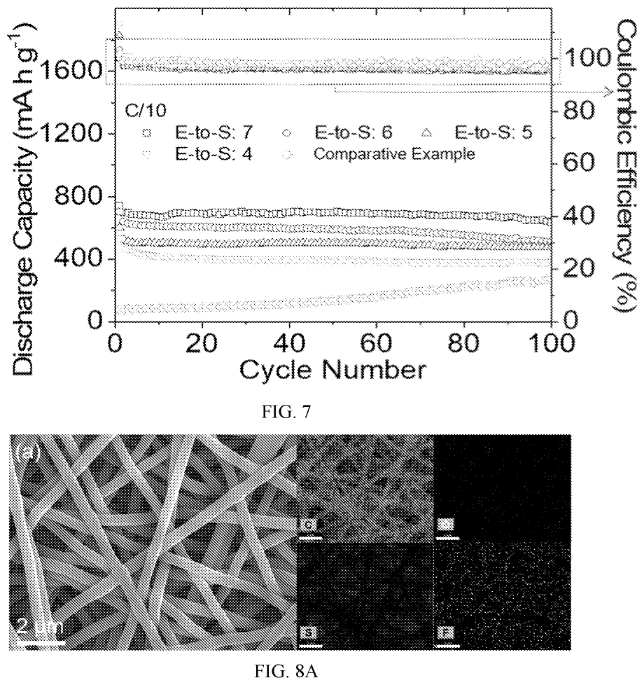

Evaluation was performed with programmable battery cycler (NEWARE, CT-4008-5V10 mA). FIG. 5 represents the rate performance at cycling rates of C/20 to C/2 of the lithium-sulfur battery of Example. FIG. 6 represents the high cycling performance of the lithium-sulfur battery (electrolyte-to-sulfur ratio is 7 μL/mg) at rates of C/10, C/7.5, C/5 and C/3. FIG. 7 represents the cycling performance of the high-loading hot-pressed carbon/sulfur composite energy-storage cathode at rate of C/10 in lithium-sulfur batteries with different electrolyte-to-sulfur ratios (electrolyte-to-sulfur ratios are 7, 6, 5, 4 respectively; unit: μL/mg) and Comparative Example.

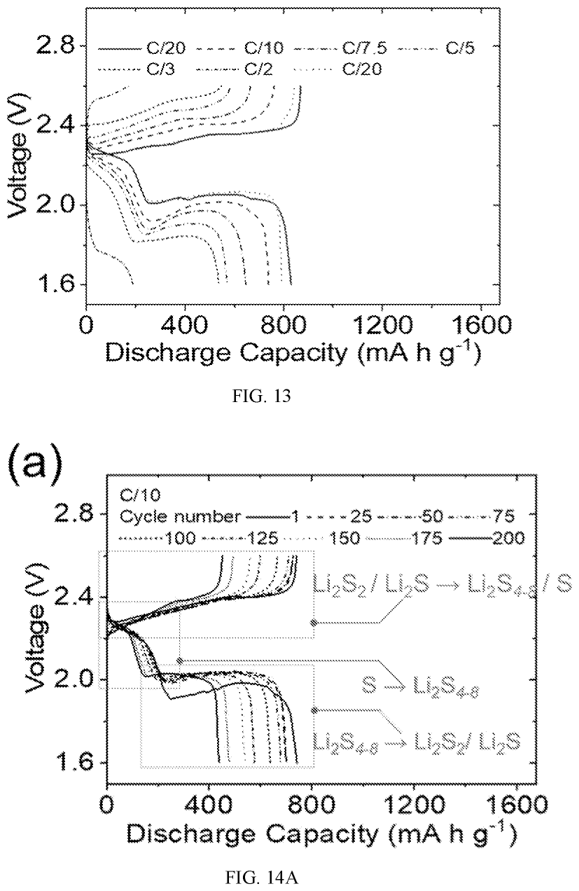

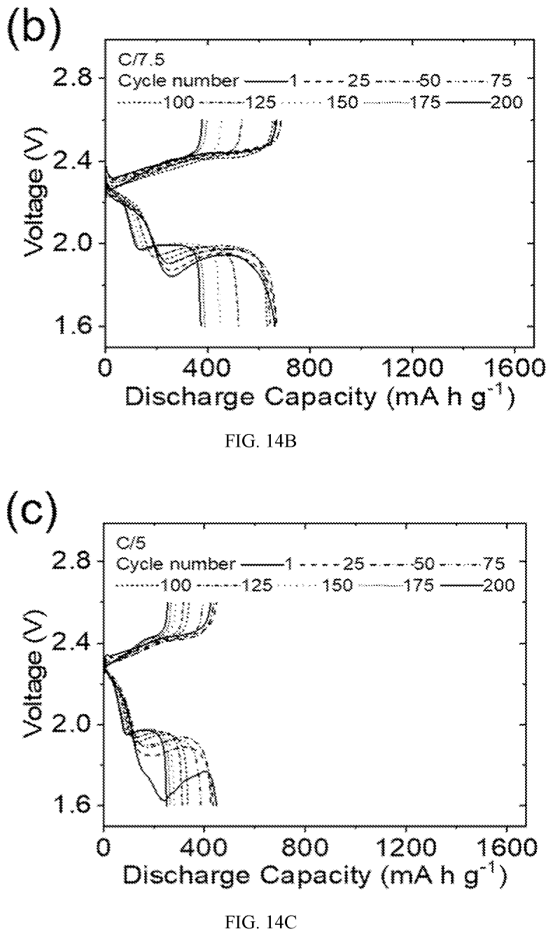

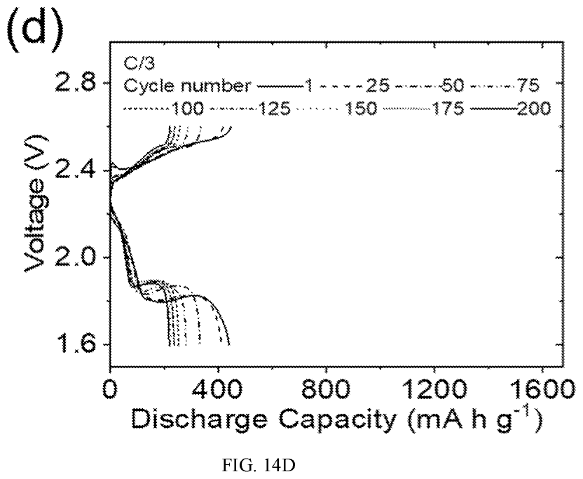

As shown in FIG. 5 and FIG. 13, the high conductivity, fast ion transfer, and sluggish polysulfide diffusion of the cathode of the Example allow the contribution of the high amount of sulfur to the high charge-storage capacity of 831 mA·h/g at cycling rate of C/20, excellent high-rate performance at rate of C/2, and high retention of 95% after returning to the rate of C/20 under the lean-electrolyte condition. As shown in FIG. 6, FIG. 14A, FIG. 14B, FIG. 14C and FIG. 14D, following the rate-performance measurements, the lean-electrolyte cell was set up to demonstrate the cycle stability exhibiting an additional 100 cycles at rate of C/10. The same hot-pressed carbon/sulfur composite energy-storage cathode had outstanding long-term rate performance at rates of C/10, C/7.5, C/5, and C/3 for 200 cycles, achieving high discharge capacity of 740, 690, 447, and 440 mA·h/g respectively, with stable discharge/charge efficiency exceeding 95%.

The performance data of the lithium-sulfur battery of the Example in FIG. 7 is shown in Table 2.

TABLE 2

| | | | electrolyte- | | | Energy | |
|---|---|---|---|---|---|---|---|
| | Sulfur | Sulfur | to-sulfur | | Highest | density | Capacity |
| | loading | content | ratio | Cycle | capacity | (mW · h/ | retention |
| | (mg/cm²) | (wt %) | (μL/mg) | life | (mA · h/g) | cm²) | (%) |
| Example 1 | 8 | 73 | 7 | 100 | 740.0 | 11.840 | 86.2 |
| Example 2 | 8 | 73 | 6 | 100 | 704.0 | 11.264 | 72.7 |
| Example 3 | 8 | 73 | 5 | 100 | 604.0 | 9.664 | 78.5 |
| Example 4 | 8 | 73 | 4 | 100 | 532.0 | 8.512 | 72.0 |
| Example 5 | 8 | 73 | 7 | 200 | 740.0 | 11.840 | 59.2 |
| Comparative | 8 | 70 | 7 | 100 | 270.3 | 4.325 | — |
| Example | | | | | | | |

Energy density = Highest capacity*Sulfur loading(g/cm²)*working potential
(plateau potential under discharge/charge profile is 2.00 V)
Capacity retention = Highest capacity/capacity after cycling*100%

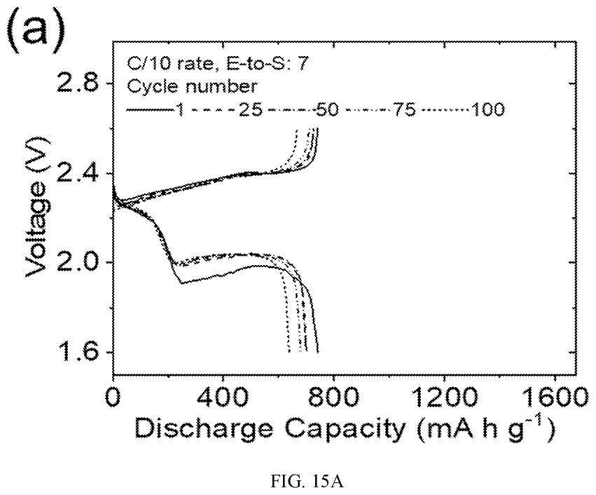

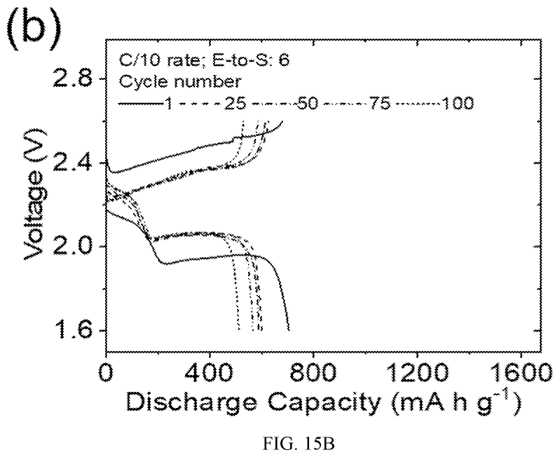

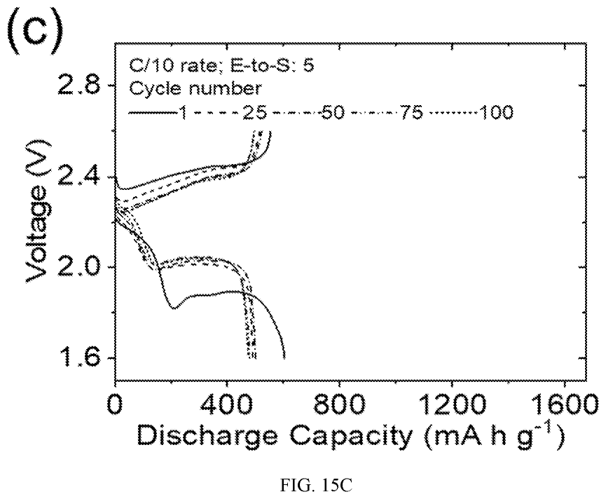

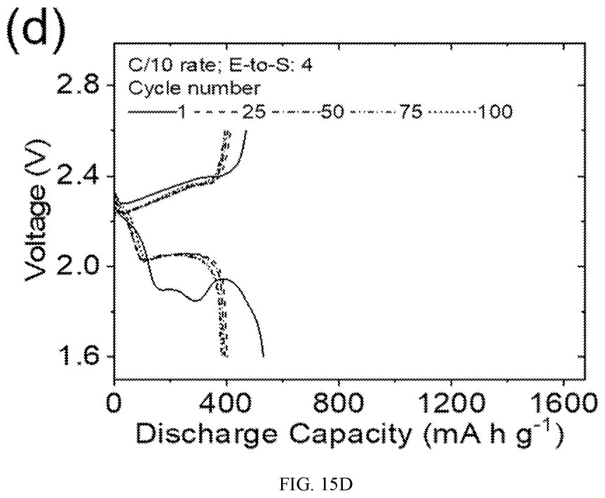

FIG. 7 represents the battery performance of the hot-pressed electrospun cathode in the lean-electrolyte battery. As the electrolyte-to-sulfur ratio (E-to-S) decreased at these critical levels, the hot-pressed carbon/sulfur composite energy-storage cathode retained stable cyclability with high charge-storage capacity and high capacity retention rates (See FIG. 7, FIG. 15A, FIG. 15B, FIG. 15C and FIG. 15D). In addition, based on the analysis results above, it was demonstrated that the hot-pressed carbon/sulfur composite energy-storage cathode had a high sulfur loading of 8 mg/cm² and a high sulfur content of 73 wt %, and the abundant sulfur converted its chemical energy to highest capacity of up to 740 mA·h/g, high energy density of 8.5-11.8 mW·h/cm² and a high areal specific capacity equivalent to 5.9-4.3 mA·h/cm². The lithium-sulfur battery of the Example is sufficient to power an electric vehicle with a power requirement of 2.0-4.0 mA·h/cm², and its performance completely fulfill the requirement of utility compared to commercial lithium-ion battery cathodes with energy density of about 10 mW·h/cm².

Compared to the Example 1-5, the lithium-sulfur battery prepared by conventional doctor blade method had significantly worse cycling performance, even though conditions such as sulfur loading, sulfur content, electrolyte-to-sulfur ratio are nearly the same as those of Example 1. The capacity retention of Comparative Example cannot be counted because its bad cycling performance.

The hot-pressed carbon/sulfur composite energy-storage cathode used conductive electrospun carbon fiber network with low mass loading as cathode substrate. Hot pressing melts the nonconductive sulfur and presses the melted sulfur into the conductive matrix such that it is accommodated. The close encapsulation of sulfur in a conductive network substrate makes the hot-pressed carbon/sulfur composite energy-storage cathode an excellent high-loading sulfur cathode. In addition, fibers having a low surface area and pore volume, which allows the smooth penetration of electrolyte. Thus, the hot-pressed carbon/sulfur composite energy-storage cathode has a longer life in the lean-electrolyte battery with superior low sulfur content ratio in electrolyte of 7-4 μL/mg. In addition, the stable cyclability of the hot-pressed carbon/sulfur composite energy-storage cathode in the lean-electrolyte battery contributed to enhanced energy density and capacity retention. Therefore, the material, configuration, and fabrication design of the advanced cathode successfully addresses the fast consumption of the electrolyte and active materials and thereby enhances overall cathode performance.

Furthermore, also as shown in FIG. 7, lithium-sulfur battery of the Example retained stable cyclability with high charge-storage capacity even though at the condition of low electrolyte-to-sulfur ratio of 7-4 μL/mg. In contrast, the lithium-sulfur battery of Comparative Example showed poor performance in cyclability and charge-storage capacity at the condition of low electrolyte-to-sulfur ratio of 7 μL/mg.

[Analysis and Verification of Cathode Materials]

Instruments and condition used in the tests including: the microstructural and elemental inspection was conducted with a field-emission scanning electron microscope (HITACHI, SU5000) with energy dispersive X-ray spectrometers (EDAX, Octane Elite EDS System) with the support of the transmission electron microscopy (HR-TEM, JEOL, JEM-2100F); X-ray diffraction analysis (Bruker, D8 DISCOVER) from 10° to 90° with Cu Kα radiation (λ=1.4506 Å); Raman spectral analysis (ULVAC, Jobin Yvon/Labram HR) is set from 150 to 3500 cm⁻¹ with a 532-nm-wavelength laser; and X-ray photoelectron spectroscopy (PHI 5000 VersaProbe).

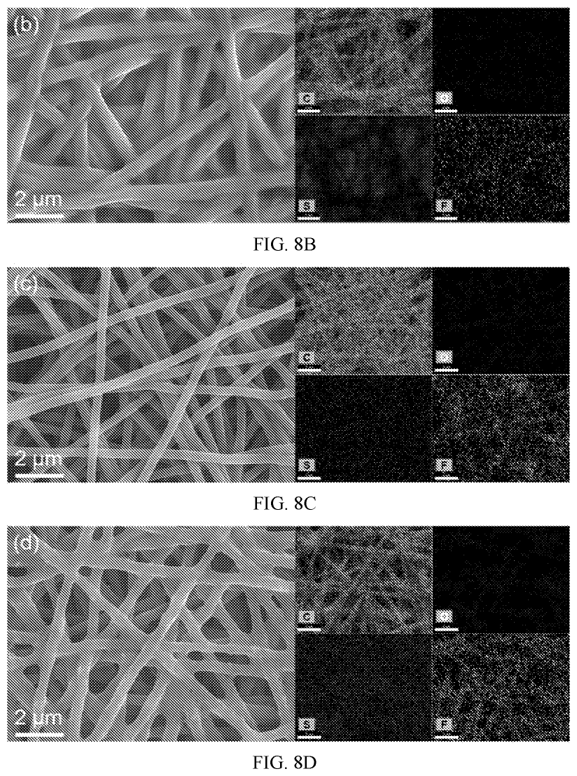

FIG. 8A, FIG. 8B, FIG. 8C and FIG. 8D represent the figures of morphology of the hot-pressed carbon/sulfur composite energy-storage cathode of the Example inspected by scanning electron microscopy/energy-dispersive X-ray spectroscopy (SEM/EDS), wherein FIG. 8A and FIG. 8B are figures by inspecting external and internal morphology of as-prepared cathode (FIG. 8A: external; FIG. 8B: internal); FIG. 8C and FIG. 8D are figures by inspecting external and internal morphology of cycled cathode after 100 cycles at rate of C/10 (FIG. 8C: external; FIG. 8D: internal). As the microstructural and elemental inspection shown in FIG. 8A, FIG. 8B, FIG. 8C and FIG. 8D, the external surface (FIG. 8A) of the as-prepared cathode was free of sulfur while the internal side (FIG. 8B), in sharp contrast, filled with molten sulfur. The cycled cathode retrieved from cycled lean-electrolyte lithium-sulfur batteries revealed the unchanged external and internal cathode morphology and elemental distribution. Inspection of the outside of the cathode through scanning electron microscopy and energy-dispersive X-ray spectroscopy confirmed that there was no sulfur trace or elemental signals (FIG. 8C). Corresponding observations of the inside of the cathode showed a high amount of sulfur characterized by strong signals of elemental sulfur (FIG. 8D), which demonstrated that the cathode of the Example had excellent sulfur accommodation and retention.

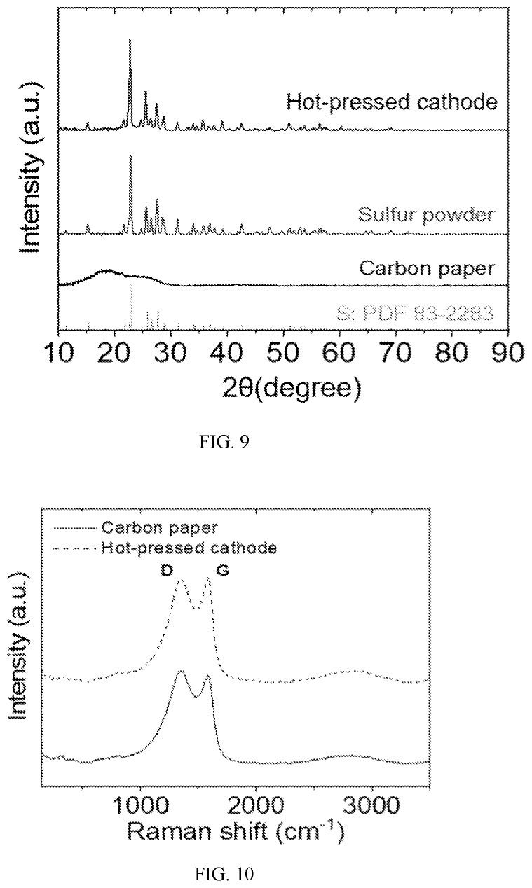

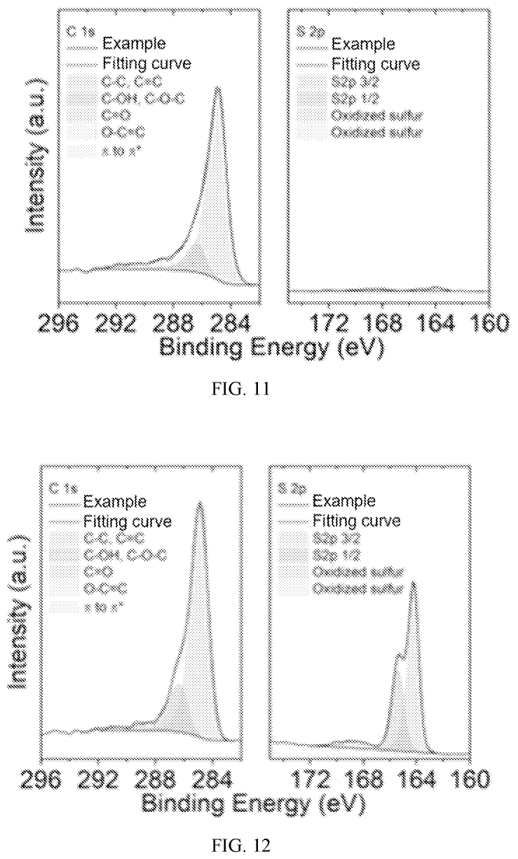

FIG. 9 represents the X-ray diffraction analysis of the cathode of the Example. FIG. 10 represents the Raman spectral analysis of the cathode of the Example. The detection in FIG. 9 shows that the impregnation of the carbonized electrospinning fiber substrate with crystalline sulfur after cooling of the hot-pressed melt sulfur. FIG. 10 shows that the carbon substrate maintained high stability and was barely damaged after the hot pressing and sulfur melting treatments. FIG. 11 represents the X-ray photoelectron spectroscopy of the external surface of cathode of the Example. FIG. 12 represents the X-ray photoelectron spectroscopy of the internal surface of cathode of the Example. As shown in FIG. 11 and FIG. 12, the detection affirmed outstanding sulfur encapsulation of the cathode of the Example. There was no sulfur peaks and strong sulfur peaks in the detection results.

In summary, the present invention integrates material, configuration, and fabrication strategies for cathode and battery development. The porous matrix of nonwoven carbon fiber with low nanoporosity allows the encapsulation of a large amount of sulfur in the carbon substrate and reduces the low electrolyte-to-sulfur ratio in lean-electrolyte lithium-sulfur batteries. The hot-pressing method also ensures the close connection of the nonconductive sulfur and the conductive carbon network, and it seals the active materials in the cathode configuration. Thus, the cathode of the present invention simultaneously has high sulfur content and high sulfur loading, and low electrolyte-to-sulfur ratio, and high discharge capacity, superior rate performance, and high cyclability. Furthermore, the use of a high-loading sulfur cathode for achieving the high electrochemical utilization of sulfur provides a high areal specific capacity and high energy density.

The described Examples are merely for exemplifying embodiments of the present invention and illustrating the technical features of the present invention rather than limiting the extent of protection of the present invention. Changes which is obvious for anyone of ordinary skill in the art or equivalent arrangements all fall within the scope of the claims of the present invention. The extent of protection of the present invention shall be determined by the appended claims.

What is claimed is:

1. A hot-pressed carbon/sulfur composite energy-storage cathode comprising:
a conductive porous substrate with specific surface area of 1˜100 m²/g before sulfur loading, and
a sulfur layer formed on the conductive porous substrate;
the cathode has a sulfur loading of at least 3 mg/cm² and sulfur content of at least 60 wt %.

2. The cathode of claim 1, wherein the conductive porous substrate is electrospun fiber carbon paper.

3. The cathode of claim 1, wherein the conductive porous substrate has a weight per unit area of 1.0-2.0 mg/cm².

4. The cathode of claim 2, wherein the conductive porous substrate has a weight per unit area of 1.0-2.0 mg/cm².

5. The cathode of claim 1, wherein the conductive porous substrate has an average pore diameter of 10.22 nm before sulfur loading.

6. A method of manufacturing a hot-pressed carbon/sulfur composite energy-storage cathode comprising:
a substrate preparing step of manufacturing fiber of polymers by electrospinning to obtain an electrospun fiber substrate which undergoes stabilization in air and then is heated in nitrogen for carbonization to obtain electrospun fiber carbon paper;
a hot-pressing step of dispersing sulfur powder evenly on a sheet of the electrospun fiber carbon paper, covering its top layer with another sheet of the electrospun fiber carbon paper and then hot-pressing the two sheets of the electrospun fiber carbon paper to form the hot-pressed carbon/sulfur composite energy-storage cathode.

7. The method of manufacturing the cathode of claim 6, wherein the substrate preparing step is conducted by using spinning solution of 10 wt % polyacrylonitrile and collecting spinning fiber with a voltage of 18˜20 kV, a solution advancing speed of 1.5 mL/min and a rotational speed of 70 rpm using a roller type collector to obtain the electrospun fiber substrate.

8. The method of manufacturing the cathode of claim 6, wherein, the hot-press step is conducted with a temperature of 145° C. and a pressure of 200 psi.

9. A lithium-sulfur battery having the cathode of claim 1 and electrolyte with electrolyte-to-sulfur ratios of 7˜4 μL/mg.

10. The lithium-sulfur battery of claim 9, wherein the areal specific capacity of the lithium-sulfur battery is 5.9˜4.3 mA·h/cm².

11. The lithium-sulfur battery of claim 9, wherein the energy density of the lithium-sulfur battery is 8.5˜11.8 mW·h/cm².
